(19) United States
(12) Patent Application Publication
(10) Pub. No.: US 2024/0273641 A1
(43) Pub. Date: Aug. 15, 2024

(54) INFORMATION PROCESSING APPARATUS, INFORMATION PROCESSING METHOD, AND STORAGE MEDIUM

(71) Applicant: KABUSHIKI KAISHA TOSHIBA, Tokyo (JP)

(72) Inventors: Kiichi GOTO, Kawasaki Kanagawa (JP); Yasutoyo TAKEYAMA, Kawasaki Kanagawa (JP); Kazunori IMOTO, Kawasaki Kanagawa (JP)

(73) Assignee: KABUSHIKI KAISHA TOSHIBA, Tokyo (JP)

(21) Appl. No.: 18/458,220

(22) Filed: Aug. 30, 2023

(30) Foreign Application Priority Data
Feb. 7, 2023 (JP) 2023-017106

(51) Int. Cl. G06Q 50/00

(52) U.S. Cl. CPC G06Q 50/01

(57) ABSTRACT

According to one embodiment, an information processing apparatus includes a processor. The processor modifies graph data to generate two pieces of new graph data. The processor extracts, by an extraction model, features of respective nodes in the graph data. The processor calculates a contrastive loss by using similarity between the extracted features. The processor calculates a structural loss by using between the extracted features. The processor updates the extraction model using the contrastive loss and the structural loss.

### CROSS-REFERENCE TO RELATED APPLICATIONS

This application is based upon and claims the benefit of priority from the Japanese Patent Application No. 2023-017106, filed Feb. 7, 2023, the entire contents of which are incorporated herein by reference.

### FIELD

Embodiments described herein relate generally to an information processing apparatus, an information processing method, and a storage medium.

### BACKGROUND

The data of the friendship between the users in the social network can be treated as a graph structure in which each user is a node and the presence or absence of the friendship between respective users is an edge. Similarly, the data of the co-selling relationship may be treated as a graph structure in which each product is a node and a co-selling relationship between respective products is a node. However, there is often no data serving as a training label in data of a friendship between users and data of a co-selling relationship of products. For this reason, it is often difficult to train a network for analyzing graph data. Therefore, also in graph analysis technology, graph unsupervised learning including self-supervised learning has attracted attention.

In the node-level graph contrastive learning which is one of the recent graph self-supervised learning, the training of the network is performed such that the node feature more suitable for the problem is extracted by augmenting the graph data by edge erasure, masking of the initial value of the node, and the like, extracting the node feature by the graph neural network (GNN) such as the graph convolutional network (GCN), and calculating the contrastive loss using the extracted node feature. The contrastive loss treats the same node between the augmented graphs as a positive example and all nodes other than the same node in the augmented graph and between the graphs as a negative example. That is, with the contrastive loss alone, all negative examples are equally treated regardless of the structure and properties of the graph. Therefore, it cannot be said that the information about the structure and property of the graph is well utilized only by the contrastive loss.

### BRIEF DESCRIPTION OF THE DRAWINGS

FIG. 1 is a block diagram illustrating a configuration of an information processing apparatus according to the first embodiment.

FIG. 2A is a diagram illustrating an example of graph data input from an input unit.

FIG. 2B is a diagram illustrating an example of graph data newly generated by a graph data modifying unit.

FIG. 2C is a diagram illustrating an example of graph data newly generated by the graph data modifying unit.

FIG. 3 is a diagram illustrating an example of a hardware configuration of the information processing apparatus.

FIG. 4 is a flowchart illustrating an operation of the information processing apparatus according to the first embodiment.

FIG. 5 is a block diagram illustrating a configuration of an information processing apparatus according to the second embodiment.

FIG. 6 is a flowchart illustrating an operation of the information processing apparatus according to the second embodiment.

### DETAILED DESCRIPTION

In general, according to one embodiment, an information processing apparatus includes a processor including hardware. The processor modifies input graph data to generate two pieces of new graph data. The processor extracts, by an extraction model, features of respective nodes constituting any two pieces of first graph data and second graph data among the input graph data and the two pieces of generated graph data. The processor calculates a contrastive loss according to similarity of a feature of a second node in the second graph data with respect to a feature of a first node in the first graph data, the second node being a same as the first node, similarity of a feature of a node, other than the second node, in the second graph data with respect to a feature of the first node, and similarity of a feature of a node, other than the first node, in the first graph data with respect to a feature of the first node. The processor calculates a structural loss according to similarity of a feature of a node in a vicinity of a fourth node in the first graph data or the second graph data with respect to a feature of a third node in the first graph data, the fourth node being a same as the third node, and similarity of a feature of a node in a vicinity of a node, other than the fourth node, in graph data to which the fourth node belongs with respect to a feature of the third node. The processor updates the extraction model using the contrastive loss and the structural loss.

Hereinafter, embodiments will be described with reference to the drawings.

### First Embodiment

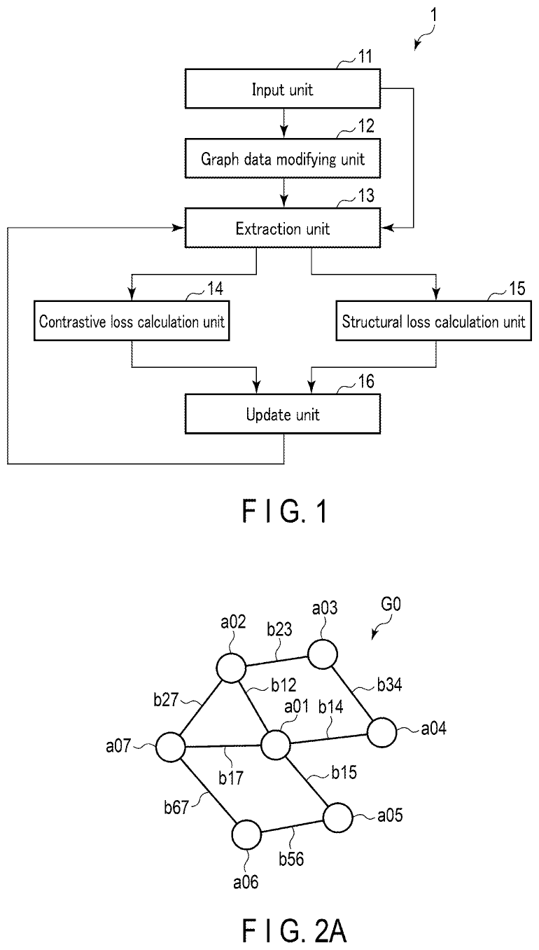

First, the first embodiment will be described. FIG. 1 is a block diagram illustrating a configuration of an information processing apparatus according to the first embodiment. The information processing apparatus 1 includes an input unit 11, a graph data modifying unit 12, an extraction unit 13, a contrastive loss calculation unit 14, a structural loss calculation unit 15, and an update unit 16.

The input unit 11 receives an input of graph data. The graph data is data representing a graph structure. The graph structure is a combination of nodes and edges representing a relationship between a plurality of things. A node is a vertex in a graph structure. The edge is a side connecting the nodes.

Each node may have attribute information such as a label, a category, and a parameter as an initial value. Furthermore, each node may have information about the degree in graph theory, that is, the number of edges connected to the node. Furthermore, the attribute information or the like of each node may be quantified by an embedding vector obtained by Deepwalk, node2vec, or the like. Furthermore, each edge may have direction information and/or weight information.

The graph data input to the input unit 11 includes at least any of data of a graphed chemical molecule structure, data of a graphed citation relationship of a paper, data of a graphed purchase relationship, data of a graphed co-selling relationship of a product, data of a graphed relationship of a user in a social network, data of a graphed design drawing of an electric circuit, data of a graphed source code of a program, and a plurality of pieces of graphed sensor data. For example, in the case of chemical molecule structure data, a node represents each atom constituting a molecule, and an edge represents a bond between atoms. In the case of data of a citation relationship of a paper, a node represents each paper, and an edge represents a relationship between citing and cited of the paper. In the case of purchase relationship data, a node represents a person or a product, and an edge represents a purchase or sales relationship between the person and the product connected. In the case of data of a co-selling relationship of products, the node represents each product, and the edge represents that the connected products are co-sold. In the case of data of a relationship of a user in a social network, a node represents each user, and an edge represents a relationship between users. In the case of data of a design drawing of an electric circuit, a node represents each circuit part, and an edge represents a wiring line. In the case of the source code of the program, a node represents a unit of each processing, and an edge represents a transition of the processing. In the case of a plurality of sensor data, a node represents each sensor, and an edge represents a relationship between sensors.

The graph data modifying unit 12 generates new two pieces of graph data from the graph data input from the input unit 11. In the embodiment, such generation of two pieces of new graph data may be referred to as modification of the graph data. In addition, such generation of two pieces of new graph data may be referred to as graph data augmentation. The new two pieces of graph data may be generated by erasing an edge and/or partially masking an initial value of a node with respect to the graph data input from the input unit 11. Generation of such two pieces of new graph data may be performed using a data augmentation method proposed in, for example, Zhu, Yanqiao, et al. “Graph contrastive learning with adaptive augmentation.” Proceedings of the Web Conference. 2021. The generation of the new two pieces of graph data does not need to be performed using this data extension method, and may be performed by an any method.

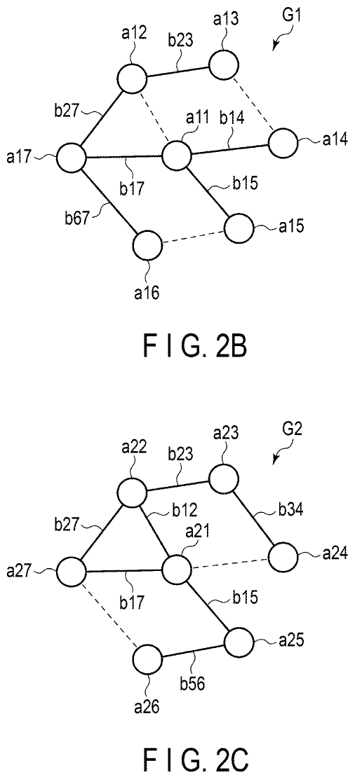

An example of modification of graph data by the graph data modifying unit 12 will be described. FIG. 2A is a diagram illustrating an example of graph data input from the input unit 11. FIGS. 2B and 2C are diagrams illustrating an example of graph data newly generated by the graph data modifying unit 12.

The graph data G0 in FIG. 2A includes, for example, seven nodes and nine edges. In the example of FIG. 2A, the edge b12 is an edge connecting the node a01 and the node a02. The edge b14 is an edge connecting the node a01 and the node a04. The edge b15 is an edge connecting the node a01 and the node a05. The edge b17 is an edge connecting the node a01 and the node a07. The edge b23 is an edge connecting the node a02 and the node a03. The edge b27 is an edge connecting the node a02 and the node a07. The edge b34 is an edge connecting the node a03 and the node a04. The edge b56 is an edge connecting the node a05 and the node a06. The edge b67 is an edge connecting the node a06 and the node a07.

The graph data modifying unit 12 generates new two pieces of graph data by erasing an edge and/or partially masking an initial value of a node with respect to the graph data G0. For example, as illustrated in FIG. 2B, the graph data modifying unit 12 generates new graph data G1 by deleting the edge b12, the edge b34, and the edge b56 from the graph data G0. For example, as illustrated in FIG. 2C, the graph data modifying unit 12 generates new graph data G2 by deleting the edge b14 and the edge b67 from the graph data G0. In FIGS. 2B and 2C, the erased edge is indicated by a broken line. The graph data G1 and G2 are obtained by erasing some edges from the graph data G0, and have a structure similar to that of the graph data G0. The graph data modifying unit 12 may generate new two pieces of graph data by adding an edge in addition to the erasure of the edge and/or the partial mask of the initial value of the node.

The extraction unit 13 extracts the node feature from each of the graph data input from the input unit 11 and one piece of graph data generated by the graph data modifying unit 12. Alternatively, the extraction unit 13 extracts the node feature from each of the two pieces of graph data generated by the graph data modifying unit 12. The extraction of the node feature is performed using an extraction model. The extraction model may be, for example, a GCN. The GCN is a neural network having a function of convolving an adjacent node for each node. The GCN in the embodiment is a neural network having a common trainable weight for all graph data. The extraction unit 13 may not necessarily be configured to extract the node feature by the GCN as long as the node features of all the nodes can be extracted with respect to the input graph data. For example, the extraction unit 13 may extract the node feature using a GNN having a message passing mechanism other than GCN, for example, a GNN such as a graph attention network (GAT), a graph isomorphism network (GIN), or GraphSAGE. Furthermore, the extraction unit 13 may project the node feature extracted by the GCN or the like by a non-linear function having a common trainable weight. In this case, a numerical value after projection is treated as the node feature.

The contrastive loss calculation unit 14 calculates a contrastive loss between two pieces of graph data from which the node feature is extracted using the node feature extracted by the extraction unit 13. As an example, the contrastive loss calculation unit 14 may calculate the contrastive loss L_{CL} based on the following Expression (1). The contrastive loss is a loss function according to similarity between two pieces of graph data and between nodes in each of the two pieces of graph data.

$${L}_{L c} = \frac{1}{2 N} {\sum }_{i = 1}^{N} ( {l}_{L C} ( {u}_{i} , {v}_{i} ) + {l}_{L C} ( {ν}_{i} , {u}_{ι} ) )$$

$${l}_{L c} ( {u}_{i} , {v}_{i} ) = - log \frac{exp ( \frac{s im ( {u}_{i} , {v}_{i} )}{τ} )}{exp ( \frac{s im ( {u}_{i} , {v}_{i} )}{τ} ) + {\sum }_{k \neq i} exp ( \frac{s i m ( {u}_{i} , {v}_{k} )}{τ} ) + {\sum }_{k \neq i} exp ( \frac{s i m ( {u}_{i} , {u}_{k} )}{τ} )} \qquad ( 1 )$$

N in Expression (1) is the number of nodes of each of the two pieces of graph data. uᵢ (i=1, 2, . . . , N) is a feature of the first node. The first node is the i-th node in the first graph data of the two pieces of graph data. vᵢ (i=1, 2, . . . , N) is a feature of the second node. The second node is a node, with the same number as the first node, in the second graph data of the two pieces of graph data. τ is a temperature parameter and may be arbitrarily determined. sim is a value of similarity between two features in parentheses. The similarity may be, for example, cosine similarity.

In addition, l_{LC} (vᵢ, uᵢ) description of which is omitted in Expression (1) can be calculated by exchanging u and v in the expression of l_{LC} (uᵢ, vᵢ).

l_{LC} (uᵢ, vᵢ) in Expression (1) corresponds to a loss according to the similarity of the feature of the second node with respect to the feature of the first node, the similarity of the feature of a node, other than the second node, in the second graph data to which the first node does not belong with respect to the feature of the first node, and the similarity of the feature of a node, other than the first node, in the first graph data to which the first node belongs with respect to the feature of the first node. Similarly, l_{LC} (uᵢ, vᵢ) in Expression (1) corresponds to a loss according to the similarity of the feature of the first node with respect to the feature of the second node, the similarity of the feature of a node, other than the first node, in the first graph data to which the second node does not belong with respect to the feature of the second node, and the similarity of the feature of a node, other than the second node, in the second graph data to which the second node belongs with respect to the feature of the second node.

For example, in the case of calculating the contrastive loss between the graph data G1 and the graph data G2, in a case where the node a11 of the graph data G1 is set as the first node, the node a21 of the graph data G2 corresponds to the second node. At this time, nodes other than the second node in the second graph data correspond to the nodes a22, a23, a24, a25, a26, and a27 of the graph data G2. Nodes other than the first node in the first graph data correspond to the nodes a12, a13, a14, a15, a16, and a17 of the graph data G1.

In addition, in the case of calculating the contrastive loss between the graph data G0 and the graph data G1, in a case where the node a01 of the graph data G0 is set as the first node, the node a11 of the graph data G1 corresponds to the second node. At this time, nodes other than the second node in the second graph data correspond to the nodes a12, a13, a14, a15, a16, and a17 of the graph data G1. Nodes other than the first node in the first graph data correspond to the nodes a02, a03, a04, a05, a06, and a07 of the graph data G0.

In the calculation of the contrastive loss, the loss for each node is calculated using a combination of a node same as any one node of the two pieces of graph data as a positive example and a combination of a node other than the node same as the one node as a negative example. Therefore, for example, in Expression (1), the loss is small in a case where the similarity between uᵢ and vᵢ is high, and the loss is large in a case where the similarity between other nodes is high.

The contrastive loss calculation unit 14 outputs, as a contrastive loss L_{CL}, a numerical value obtained by averaging the losses calculated for all the nodes of the two pieces of graph data from which the node feature is extracted based on Expression (1). The calculation formula of the contrastive loss L_{CL} of Expression (1) is an example, and may be appropriately changed.

The structural loss calculation unit 15 calculates a structural loss between two pieces of graph data from which the node feature is extracted using the node feature extracted by the extraction unit 13. The structural loss is a loss function in which homophily in the graph is considered. The homophily of the graph is a property that appears in a local structure of the graph, and is a property that attributes of close nodes are likely to be similar to each other and attributes of distant nodes are unlikely to be similar to each other. As an example, the structural loss calculation unit 15 may calculate a structural loss L_{AER} due to average edge reconstruction represented by the following Expression (2). The structural loss L_{AER} due to the average edge reconstruction is a loss function in consideration of a property of a graph in which a combination of neighboring nodes is likely to be similar in the case of the same node in a case where two pieces of similar graph data are compared. The property that a combination of neighboring nodes is similar in the case of the same node in a case where two pieces of graph data are compared is a property that is generally established because adjacent nodes do not need to be similar to each other. Here, a neighboring node of a certain node in the embodiment may include, in addition to an adjacent node whose edge is directly connected to the certain node, a node whose edge is not directly connected to the certain node but is at a close position.

$${L}_{AER} = \frac{1}{2 N} {\sum }_{i = 1}^{N} ( {l}_{AER} ( {u}_{i} , {ν}_{i} ) + {l}_{AER} ( {v}_{i} , {u}_{i} ) )$$

$${l}_{AER} = - log \frac{exp ( \frac{s i m ( {u}_{i} , {X}_{i} )}{τ} )}{{\sum }_{k} e x p ( \frac{s i m ( {u}_{i} , {X}_{k} )}{τ} )} - log \frac{exp ( \frac{s i m ( {ν}_{i} , {Y}_{i} )}{τ} )}{{\sum }_{k} exp ( \frac{s i m ( {v}_{i} , {Y}_{k} )}{τ} )} \qquad ( 2 )$$

$${X}_{i} = \frac{1}{\vert {N}_{1 , i} \vert} {\sum }_{j ∈ {N}_{1 , i}} {u}_{j} , {y}_{i} = \frac{1}{\vert {N}_{2 , i} \vert} {\sum }_{j ∈ {N}_{2 , i}} {ν}_{j}$$

N in Expression (2) is the number of nodes of each of the two pieces of graph data. uᵢ (i=1, 2, . . . , N) is a feature of the third node. The third node is the i-th node in any graph data of the two pieces of graph data. vᵢ (i=1, 2, . . . , N) is a feature of the fourth node. The fourth node is a node, with the same number as the third node, in any graph data of the two pieces of graph data. Xᵢ (i=1, 2, . . . , N) is an average value of features of neighboring nodes of the third node. N_{1,i} represents a set of neighboring nodes of the third node, and an absolute value of N_{1,i} represents the number of neighboring nodes. The neighboring node of the third node may be one or more nodes whose edges are connected to the third node. In addition, Yᵢ (i=1, 2, . . . , N) is an average value of features of neighboring nodes of the fourth node. N_{2,i} represents a set of neighboring nodes of the fourth node, and an absolute value of N_{2,i} represents the number of neighboring nodes. The neighboring node of the fourth node may be one or more nodes whose edges are connected to the fourth node. τ is a temperature parameter and may be arbitrarily determined. sim is a value of similarity between two features in parentheses. The similarity may be, for example, cosine similarity.

In addition, l_{AER} in Expression (2) is l_{AER} (uᵢ, vᵢ). l_{AER} (vᵢ, uᵢ) description of which is omitted in Expression (2) can be calculated by exchanging u and v without exchanging X and Y in the expression of the l_{AER} (vᵢ, uᵢ).

l_{AER} (vᵢ, uᵢ) in Expression (2) corresponds to a loss according to the similarity of the average feature of the neighboring nodes of the third node with respect to the feature of the third node and the similarity of the feature of the neighboring node of the fourth node with respect to the feature of the fourth node. Similarly, l_{AER} (vᵢ, uᵢ) in Expression (2) corresponds to a loss according to the similarity of the feature of the neighboring node of the third node with respect to the feature of the fourth node and the similarity of the feature of the neighboring node of the fourth node with respect to the feature of the third node.

For example, in the case of calculating the structural loss between the graph data G1 and the graph data G2, in a case where the node a11 of the graph data G1 is set as the third node, the node a11 of the graph data G1 and the node a21 of the graph data G2 correspond to the fourth node. At this time, for example, one or more nodes among the nodes a14, a15, and a17 which are adjacent nodes edges of which are connected to the node a11, for example, all the nodes a14, a15, and a17 correspond to the neighboring nodes of the third node. In addition, in a case where the fourth node is the node a11, for example, one or more nodes among the nodes a14, a15, and a17 that are adjacent nodes the edges of which are connected to the node a11, for example, the nodes a14, a15, and a17 correspond to the neighboring nodes of the fourth node, and in a case where the fourth node is the node a21, for example, one or more nodes among the nodes a22, a25, and a27 that are adjacent nodes the edge of which are connected to the node a21, for example, all the nodes a22, a25, and a27 correspond to the neighboring nodes of the fourth node. Nodes whose edges are connected to the nodes a14, a15, and a17 may be further included as neighboring nodes of the third node. Furthermore, nodes whose edges are connected to the nodes a14, a15, and a17 and nodes whose edges are connected to the nodes a22, a25, and a27 may be further included as neighboring nodes of the fourth node.

In addition, for example, in a case where the structural loss between the graph data G0 and the graph data G1 is calculated, in a case where the node a01 of the graph data G0 is set as the third node, the node a01 of the graph data G0 and the node a11 of the graph data G1 correspond to the fourth node. At this time, for example, one or more nodes among the nodes a02, 04, a05, and a07, which are adjacent nodes whose edges are connected to the node a01, for example, all the nodes a02, a04, a05, and a07 correspond to the neighboring nodes of the third node. In addition, in a case where the fourth node is the node a01, for example, one or more nodes among the nodes a02, a04, a05, and a07 which are adjacent nodes whose edges are connected to the node a01, for example, all the nodes a02, a04, a05, and a07 correspond to the neighboring nodes of the fourth node, and in a case where the fourth node is the node a11, one or more nodes among the nodes a14, a15, and a17 which are adjacent nodes whose edges are connected to the node a11, for example, all the nodes a14, a15, and a17 correspond to the neighboring nodes of the fourth node. Nodes whose edges are connected to the nodes a02, a04, a05, and a07 may be further included as neighboring nodes of the third node. In addition, nodes whose edges are connected to the nodes 02, a04, a05, and a07 and nodes whose edges are connected to the nodes a14, a15, and a17 may be further included as neighboring nodes of the fourth node.

In the calculation of the structural loss due to the average edge reconstruction, the loss for each node is calculated with a set of one node and a neighboring node thereof in the two graph structures as a positive example, and a set of the one node and a neighboring node of a node other than the one node as a negative example. Therefore, for example, in Expression (2), the loss is small in a case where the similarity between uᵢ and Xᵢ, the similarity between vᵢ and Yᵢ, the similarity between uᵢ and Yᵢ, and the similarity between vᵢ and Xᵢ are high, and the loss is large in a case where the similarity between other nodes is high.

The structural loss calculation unit 15 outputs, as the structural loss L_{AER} of the average edge reconstruction, a numerical value obtained by averaging the losses calculated for all the nodes of the two pieces of graph data from which the node features are extracted based on Expression (2). The calculation formula of the contrastive loss L_{AER} in Expression (2) is an example, and may be appropriately changed.

In addition, the structural loss calculation unit 15 may calculate a structural loss L_{ER} due to edge reconstruction represented by the following Expression (3) instead of the structural loss L_{AER} due to average edge reconstruction. The structural loss L_{ER} due to edge reconstruction is a loss function in consideration of a property of a graph in which adjacent nodes are likely to be similar to each other and nodes adjacent to the adjacent nodes are likely to be similar to each other in a case where two pieces of similar graph data are compared. In a case where two pieces of graph data are compared with each other, the property of the graph in which adjacent nodes are also likely to be similar to each other is likely to be established particularly in a graph having strong homophily. The graph having strong homophily is, for example, a graph of a relationship between users in a social network or a graph of a relationship between citing and cited of a paper. Expressions (2) and (3) may be selectively used according to the property of each piece of graph data. For example, Expression (3) may be used for graph data having a structure having particularly strong homophily.

$${L}_{ER} = \frac{1}{2 N} {\sum }_{i = 1}^{N} ( {l}_{ER} ( {u}_{i} ) + {l}_{ER} ( {v}_{i} ) )$$

$${l}_{ER} = {\sum }_{j ∈ {N}_{1 , i}} - log \frac{exp ( \frac{s i m ( {u}_{i} , {u}_{j} )}{τ} )}{{\sum }_{k} exp ( \frac{s i m ( {u}_{i} , {u}_{k} )}{τ} )} + {\sum }_{j ∈ {N}_{2 , i}} - log \frac{exp ( \frac{s i m ( {u}_{i} , {v}_{j} )}{τ} )}{{\sum }_{k} exp ( \frac{s i m ( {u}_{i} , {v}_{k} )}{τ} )} \qquad ( 3 )$$

N in Expression (3) is the number of nodes of each of the two pieces of graph data. uᵢ (i=1, 2, . . . , N) is a feature of the third node. The third node is the i-th node in any graph data of the two pieces of graph data. vᵢ (i=1, 2, . . . , N) is a feature of the fourth node. The fourth node is a node, with the same number as the third node, in any graph data of the two pieces of graph data. uⱼ is a feature of one node among neighboring nodes of the third node. N_{1,i} represents a set of neighboring nodes of the third node. The neighboring node of the third node may be one or more nodes whose edges are connected to the third node. In addition, vⱼ is a feature of one node among neighboring nodes of the fourth node. N_{2,i} represents a set of neighboring nodes of the fourth node. The neighboring node of the fourth node may be one or more nodes whose edges are connected to the fourth node. τ is a temperature parameter and may be arbitrarily determined. sim is a value of similarity between two features in parentheses. The similarity may be, for example, cosine similarity.

In addition, l_{ER} in Expression (3) is l_{ER} (uᵢ). l_{ER} (vᵢ) description of which is omitted in Expression (3) can be calculated by exchanging u and v in the expression of l_{ER} (uᵢ).

l_{ER} (uᵢ) in Expression (3) corresponds to a loss according to the similarity of the feature of the neighboring node of the third node with respect to the feature of the third node and the similarity of the feature of the neighboring node of the fourth node with respect to the feature of the third node. Similarly, l_{ER} (vᵢ) in Expression (3) corresponds to a loss according to the similarity of the feature of the neighboring node of the third node with respect to the feature of the fourth node and the similarity of the feature of the neighboring node of the fourth node with respect to the feature of the fourth node.

The relationship between the third node and the fourth node in the edge reconstruction is the same as the relationship between the third node and the fourth node in the average edge reconstruction. For example, in the case of calculating the structural loss between the graph data G1 and the graph data G2, in a case where the node a11 of the graph data G1 is set as the third node, the node a11 of the graph data G1 and the node a21 of the graph data G2 correspond to the fourth node. At this time, for example, one or more nodes among the nodes a14, a15, and a17, for example, all the nodes a14, a15, and a17 correspond to the neighboring nodes of the third node. In addition, in a case where the fourth node is the node a11, for example, one or more nodes among the nodes a14, a15, and a17, for example, the nodes a14, a15, and a17 correspond to a neighboring node of the fourth node, and in a case where the fourth node is the node a21, for example, one or more nodes among the nodes a22, a25, and a27 for example, all the nodes a22, a25, and a27 correspond to a neighboring node of the fourth node.

In the calculation of the structural loss due to edge reconstruction, the loss for each node is calculated with a neighboring node of each of one node or a node same as the one node in the two graph structures as a positive example, and a node other than a neighboring node of each of one node or a node same as the one node as a negative example. Therefore, for example, in Expression (3), the loss is small in a case where the similarity between uᵢ and uⱼ or the similarity between uᵢ and vⱼ is high, and the loss is large in a case where the similarity between other nodes is high.

Here, the description returns to FIG. 1. The update unit 16 receives the contrastive loss L_{LC} from the contrastive loss calculation unit 14 and receives the structural loss L_{AER} Or L_{ER} from the structural loss calculation unit 15. Then, the update unit 16 updates the extraction unit 13 based on the contrastive loss and the structural loss. For example, as expressed in the following Expression (4), the update unit 16 calculates a weighted sum of the contrastive loss L_{LC} and the structural loss L_{AER} as a final loss L and optimizes the trainable weight of the extraction unit 13 so as to minimize the final loss. λ in Expression (4) is a weight coefficient and can be arbitrarily set within a range of 0-1. In Expression (4), L_{AER} is used as the structural loss, but it goes without saying that L_{ER} may be used as the structural loss.

$$L = {L}_{L C} + λ {L}_{LER} \qquad ( 4 )$$

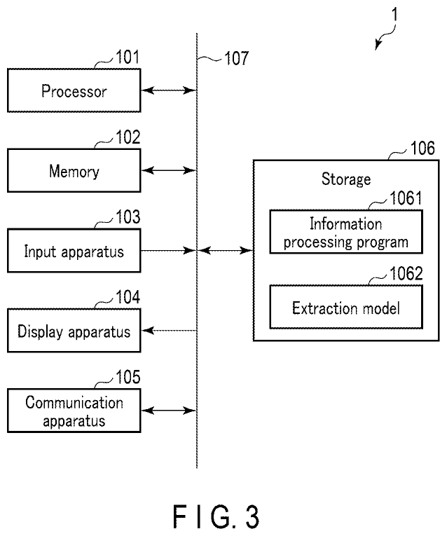

Hereinafter, an example of a hardware configuration of the information processing apparatus will be described. FIG. 3 is a diagram illustrating an example of a hardware configuration of the information processing apparatus. The information processing apparatus is a computer, and includes, for example, a processor 101, a memory 102, an input apparatus 103, a display apparatus 104, a communication apparatus 105, and a storage 106 as hardware. The processor 101, the memory 102, the input apparatus 103, the display apparatus 104, the communication apparatus 105, and the storage 106 are connected to a bus 107.

The processor 101 is a processor that controls the overall operation of the information processing apparatus. The processor 101 can operate as the input unit 11, the graph data modifying unit 12, the extraction unit 13, the contrastive loss calculation unit 14, the structural loss calculation unit 15, and the update unit 16, for example, by executing a program stored in the storage 106. The processor 101 is, for example, a CPU. The processor 101 may be an MPU, a GPU, an ASIC, an FPGA, or the like. The processor 101 may be a single CPU or the like, or may be a plurality of CPUs or the like.

The memory 102 includes a ROM and a RAM. The ROM is a nonvolatile memory. The ROM stores a startup program and the like of the information processing apparatus. The RAM is a volatile memory. The RAM is used as a working memory at the time of processing in the processor 101, for example.

The input apparatus 103 is an input apparatus such as a touch panel, a keyboard, or a mouse. In a case where the input apparatus 103 is operated, a signal corresponding to the operation content is input to the processor 101 via the bus 107. The processor 101 performs various processes according to this signal. The input apparatus 103 is used to input graph data, for example.

The display apparatus 104 is a display apparatus such as a liquid crystal display or an organic EL display. Instead of or in addition to the display apparatus 104, an output apparatus for various types of information such as a printer may be provided. Furthermore, the display apparatus 104 is not necessarily provided in the information processing apparatus, and may be an external display apparatus capable of communicating with the information processing apparatus.

The communication apparatus 105 is a communication apparatus for the information processing apparatus to communicate with an external device. The communication apparatus 105 may be a communication apparatus for wired communication or a communication apparatus for wireless communication.

The storage 106 is, for example, a storage such as a hard disk drive or a solid state drive. The storage 106 stores various programs executed by the processor 101, such as an information processing program 1061.

In addition, the storage 106 may store an extraction model 1062 such as a GCN. The extraction model 1062 may be stored in an apparatus different from the information processing apparatus. In this case, the information processing apparatus acquires necessary information by accessing another apparatus using the communication apparatus 105.

The bus 107 is a data transfer path for exchanging data between the processor 101, the memory 102, the input apparatus 103, the display apparatus 104, the communication apparatus 105, and the storage 106.

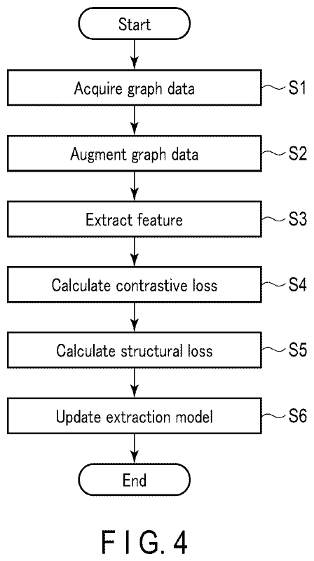

Next, an operation of the information processing apparatus according to the first embodiment will be described. FIG. 4 is a flowchart illustrating an operation of the information processing apparatus according to the first embodiment. The processing of FIG. 4 is executed by the processor 101.

In step S1, the processor 101 acquires graph data. As described above, the graph data may be input by a user. For example, the user operates the input apparatus 103 to input the data of the graph structure.

In step S2, the processor 101 modifies the acquired graph data to generate two pieces of new graph data. For example, the processor 101 generates two pieces of new graph data by erasing an edge and/or partially masking an initial value of a node with respect to the acquired graph data.

In step S3, the processor 101 extracts node features of the two pieces of graph data. The two pieces of graph data may be the two pieces of graph data generated in step S2. Alternatively, the two pieces of graph data may be the graph data acquired in step S1 and one piece of graph data generated in step S2. The node feature of the graph data is extracted by an extraction model 1062 such as the GCN. The processor 101 inputs the two pieces of graph data to the extraction model 1062 to obtain the node feature of each node of the two pieces of graph data.

In step S4, the processor 101 calculates the contrastive loss from Expression (1) based on the node feature of each node of the two pieces of graph data. In step S5, the processor 101 calculates the structural loss from Expression (2) or Expression (3) based on the node feature of each node of the two pieces of graph data. The processing in steps S4 and S5 may be performed sequentially or in parallel.

In step S6, the processor 101 updates the extraction model 1062 using the contrastive loss and the structural loss. For example, the processor 101 calculates the weighted sum of the contrastive loss and the structural loss as the final loss based on Expression (4), and updates the trainable weight of the extraction model 1062 to minimize the final loss. Thereafter, the process of FIG. 4 ends.

As described above, according to the first embodiment, the information processing apparatus optimizes the trainable weight in the extraction unit of the node feature based on the contrastive loss and the structural loss. Since the structural loss is used as the loss in addition to the contrastive loss, the positive example and the negative example can be determined by the similarity of the local structures in the graph data. As a result, it is expected that optimization of the trainable weight in the extraction unit is performed more accurately.

### Second Embodiment

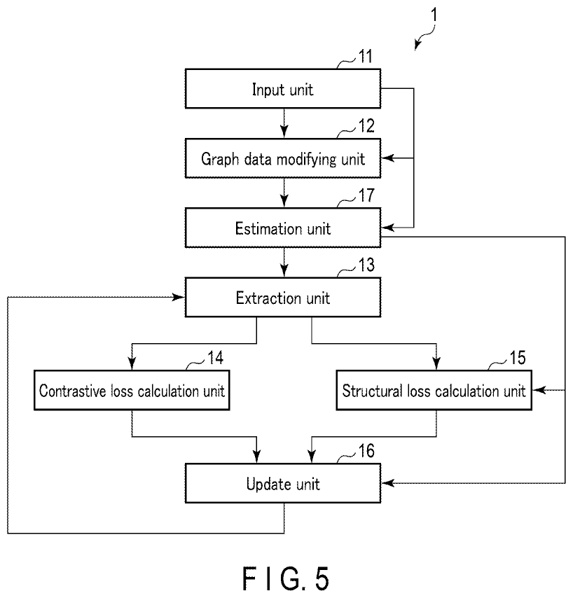

Next, the second embodiment will be described. FIG. 5 is a block diagram illustrating a configuration of an information processing apparatus according to the second embodiment. The information processing apparatus 1 includes an estimation unit 17 in addition to an input unit 11, a graph data modifying unit 12, an extraction unit 13, a contrastive loss calculation unit 14, a structural loss calculation unit 15, and an update unit 16. In the second embodiment, a processor 101 can also operate as the estimation unit 17.

The estimation unit 17 estimates the property of the graph structure of each of the graph data input from the input unit 11 and one piece of graph data generated by the graph data modifying unit 12. Alternatively, the estimation unit 17 estimates the property of the graph structure of each of the two pieces of graph data generated by the graph data modifying unit 12. The property of the graph structure includes, for example, homophily and distribution of the degree of the node. The homophily is estimated as a degree to which nodes having similar attributes in the vicinity in the graph data are distributed. The estimation unit 17 can estimate the homophily of the graph from the similarity of the local structure of the graph data, for example. The similarity of the local structure can be calculated from an inner product of initial values of nodes, cosine similarity, and the like. For example, the estimation unit 17 estimates that the homophily of the graph data having a large similarity of the local structure is strong. The estimation unit 17 outputs information about the estimation result of the property of the graph structure to the contrastive loss calculation unit 14 and the update unit 16.

The structural loss calculation unit 15 according to the second embodiment calculates a structural loss based on the estimation result of homophily by the estimation unit 17. For example, the structural loss calculation unit 15 limits not to calculate a loss for a node whose degree in graph data is a predetermined value or more. The predetermined value is, for example, a value of 2 or more. This is because the node with a large degree may not be suitable for the average feature of the peripheral structure to represent the node, and is likely to be a noise in the calculation of the structural loss.

The update unit 16 according to the second embodiment adjusts the weighting of the contrastive loss and the structural loss based on the estimation result of the homophily by the estimation unit 17, and then optimizes the trainable weight of the extraction unit 13. For example, the update unit 16 sets the weight λ of the structural loss to be large in a case where it is estimated that homophily due to similarity of local structures is strong, and sets the weight λ of the structural loss to be small in a case where it is estimated that homophily due to similarity of local structures is weak. This is because the structural loss calculated from the graph data having weak homophily tends to include noise.

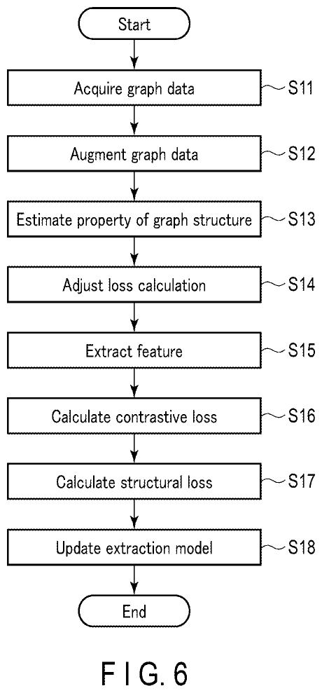

Next, an operation of the information processing apparatus according to the second embodiment will be described. FIG. 6 is a flowchart illustrating an operation of the information processing apparatus according to the second embodiment. The processing of FIG. 6 is executed by the processor 101.

In step S11, the processor 101 acquires graph data. As described above, the graph data may be input by a user. For example, the user operates the input apparatus 103 to input the data of the graph structure.

In step S12, the processor 101 modifies the acquired graph data to generate two pieces of new graph data. For example, the processor 101 generates two pieces of new graph data by erasing an edge and/or partially masking an initial value of a node with respect to the acquired graph data.

In step S13, the processor 101 estimates the property of the graph structure of the two pieces of graph data. The two pieces of graph data may be the two pieces of graph data generated in step S12. Alternatively, the two pieces of graph data may be the graph data acquired in step S11 and one piece of graph data generated in step S12. The estimation of the property of the graph structure may be performed based on the similarity of the local structure of the graph data and the degree of the node.

In step S14, the processor 101 adjusts the loss calculation based on the estimated property of the graph structure. For example, the processor 101 sets a node having a degree of a predetermined value or more as a node to be excluded from structural loss calculation. In addition, for example, the processor 101 sets the value of the weight λ according to the strength of the homophily due to the similarity of the local structure.

In step S15, the processor 101 extracts node features of the two pieces of graph data. The two pieces of graph data may be the two pieces of graph data generated in step S12. Alternatively, the two pieces of graph data may be the graph data acquired in step S11 and one piece of graph data generated in step S12. The node feature of the graph data is extracted by an extraction model 1062 such as the GCN. The processor 101 inputs the two pieces of graph data to the extraction model 1062 to obtain the node feature of each of the two pieces of graph data.

In step S16, the processor 101 calculates the contrastive loss from Expression (1) based on the node feature of each of the two pieces of graph data. In step S17, based on the node feature of each of the two pieces of graph data, the processor 101 calculates the structural loss from Expression (2) or Expression (3) in which the node to be calculated is limited. The processing in steps S16 and S17 may be performed sequentially or in parallel.

In step S18, the processor 101 updates the extraction model 1062 using the contrastive loss and the structural loss. For example, the processor 101 calculates the weighted sum of the contrastive loss and the structural loss as the final loss based on Expression (4) in which the weight λ is adjusted, and updates the trainable weight of the extraction model 1062 so as to minimize the final loss. Thereafter, the process of FIG. 6 ends.

As described above, according to the second embodiment, the information processing apparatus estimates the property of the graph structure of the graph data and adjusts the loss calculation based on the estimation result of the property of the graph structure. For example, by limiting the node used for the calculation of the structural loss according to the degree of the node, noise reduction in the calculation of the structural loss is expected. In addition, by adjusting the weighting of the contrastive loss and the structural loss according to the similarity of the local structures, optimization of the trainable weight in the extraction unit can be performed with the loss according to the strength of the homophily of the graph data. As a result, it is expected that optimization of the trainable weight in the extraction unit is performed more accurately.

### Third Embodiment

Next, the third embodiment will be described. As described in the first embodiment and the second embodiment, a graph data modifying unit 12 generates two new graph structures by modifying the original graph structure. For this reason, there is a possibility that the graph data generated by the graph data modifying unit 12 loses information about connection of the important edge in the original graph structure. For example, in the case of data of a graphed design drawing of an electric circuit, a connection relationship between circuit parts is more important than each circuit part. In graph data in which such a connection relationship is important, even if only one edge is erased, the graph data may be regarded as graph data having a completely different structure. In the calculation of the structural loss represented by Expression (2) or Expression (3), the structural loss between two pieces of graph data with less modification by the graph data modifying unit 12 tends to be small. For this reason, depending on the type of graph data, a structural loss between two pieces of graph data to be regarded as graph data having completely different structures is small, and appropriate training may not be performed.

In the third embodiment, for example, for graph data in which a connection relationship between nodes is particularly important, such as data of a graphed design drawing of an electric circuit, a structural loss may be calculated without using modified graph data. That is, in the third embodiment, the structural loss may be calculated according to Expression (5) or Expression (6) instead of Expression (2) or Expression (3). Here, Expression (5) is an example of a calculation formula of a structural loss of average edge reconstruction in the third embodiment, and Expression (6) is an example of a calculation formula of a structural loss of edge reconstruction in the third embodiment.

$${L}_{AER} = \frac{1}{N} {\sum }_{i = 1}^{N} {l}_{AER} ( {w}_{i} )$$

$${l}_{AER} ( {w}_{i} ) = - log \frac{exp ( \frac{s i m ( {w}_{i} , {Z}_{i} )}{τ} )}{{\sum }_{k} exp ( \frac{s i m ( {w}_{i} , {Z}_{k} )}{τ} )} \qquad ( 5 )$$

$${Z}_{i} = \frac{1}{\vert {N}_{i} \vert} {\sum }_{j ∈ {N}_{i}} {w}_{j}$$

$${L}_{ER} = \frac{1}{N} {\sum }_{i = 1}^{N} {l}_{ER} ( {w}_{i} )$$

$${l}_{ER} = {\sum }_{j ∈ {N}_{i}} - log \frac{exp ( \frac{s i m ( {w}_{i} , {w}_{j} )}{τ} )}{{\sum }_{k} exp ( \frac{s i m ( {w}_{i} , {w}_{k} )}{r} )} \qquad ( 6 )$$

N in Expression (5) is the number of nodes of the graph data acquired from the input unit 11. wᵢ (i=1, 2, . . . , N) is a feature of the third node. The third node in Expression (5) is the i-th node in the graph data input from the input unit 11. Zᵢ is an average value of features of neighboring nodes of the third node. Nᵢ represents a set of neighboring nodes of the third node. The neighboring node of the third node may be one or more nodes whose edges are connected to the third node. τ is a temperature parameter and may be arbitrarily determined. sim is a value of similarity between two features in parentheses. The similarity may be, for example, cosine similarity. Furthermore, N in Expression (6) is the number of nodes of the graph data acquired from the input unit 11. wᵢ (i=1, 2, . . . , N) is a feature of the third node. The third node in Expression (6) is the i-th node in the graph data input from the input unit 11. wⱼ is a feature of one node among neighboring nodes of the third node. Nᵢ represents a set of neighboring nodes of the third node. The neighboring node of the third node may be one or more nodes whose edges are connected to the third node. τ is a temperature parameter and may be arbitrarily determined. sim is a value of similarity between two features in parentheses. The similarity may be, for example, cosine similarity.

Expression (5) does not mean that the structural loss of the average edge reconstruction between two pieces of graph data is calculated, but means that the structural loss of the average edge reconstruction is calculated in one piece of graph data input from the input unit 11. Similarly, Expression (6) does not mean that the structural loss of the edge reconstruction between two pieces of graph data is calculated, but means that the structural loss of the edge reconstruction is calculated in one piece of graph data input from the input unit 11.

As described above, according to the third embodiment, the structural loss is calculated only with the unmodified graph data input from the input unit 11. This avoids a situation in which training based on modified graph data is noise instead.

The instruction illustrated in the processing procedure illustrated in the above-described embodiment can be executed based on a program that is software. By storing this program in advance and reading this program, a general-purpose computer system can obtain an effect similar to the effect of the information processing apparatus described above. The instructions described in the above-described embodiments are recorded in a magnetic disk (flexible disk, hard disk, etc.), an optical disk (CD-ROM, CD-R, CD-RW, DVD-ROM, DVD±R, DVD±RW, Blu-ray (registered trademark) Disc, and the like), a semiconductor memory, or a recording medium similar thereto as a program that can be executed by a computer. The storage format may be any form as long as it is a recording medium readable by a computer or an embedded system. In a case where the computer reads a program from the recording medium and causes the CPU to execute an instruction described in the program based on the program, the operation similar to that of the information processing apparatus according to the above-described embodiment can be realized. Of course, in a case where the computer acquires or reads the program, the program may be acquired or read through a network.

In addition, an operating system (OS) running on a computer, database management software, middleware (MW) such as a network, or the like based on an instruction of a program installed from a recording medium to the computer or an embedded system may execute part of each process for realizing the present embodiment.

Furthermore, the recording medium in the present embodiment is not limited to a medium independent of a computer or an embedded system, and includes a recording medium that downloads and stores or temporarily stores a program transmitted via a LAN, the Internet, or the like.

Furthermore, the number of recording media is not limited to one, and a case where the processing in the present embodiment is executed from a plurality of media is also included in the recording media in the present embodiment, and the configuration of the media may be any configuration.

Note that the computer or the embedded system in the present embodiment is for executing each processing in the present embodiment based on a program stored in a recording medium, and may have any configuration such as an apparatus including one of a personal computer, a microcomputer, and the like, a system in which a plurality of apparatuses is connected to a network, and the like.

In addition, the computer in the present embodiment is not limited to a personal computer, and includes an arithmetic processing apparatus, a microcomputer, and the like included in an information processing device, and collectively refers to a device and an apparatus capable of realizing a function in the present embodiment by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a processor including hardware configured to:
modify input graph data to generate two pieces of new graph data;
extract, by an extraction model, features of respective nodes constituting any two pieces of first graph data and second graph data among the input graph data and the two pieces of generated graph data;
calculate a contrastive loss according to similarity of a feature of a second node in the second graph data with respect to a feature of a first node in the first graph data, the second node being a same as the first node, similarity of a feature of a node, other than the second node, in the second graph data with respect to a feature of the first node, and similarity of a feature of a node, other than the first node, in the first graph data with respect to a feature of the first node;
calculate a structural loss according to similarity of a feature of a node in a vicinity of a fourth node in the first graph data or the second graph data with respect to a feature of a third node in the first graph data, the fourth node being a same as the third node, and similarity of a feature of a node in a vicinity of a node, other than the fourth node, in graph data to which the fourth node belongs with respect to a feature of the third node; and
update the extraction model using the contrastive loss and the structural loss.

2. The information processing apparatus according to claim 1, wherein
a node in a vicinity of the fourth node includes one or more nodes whose edges are connected to the fourth node, and
a node in a vicinity of a node other than the fourth node includes one or more nodes whose edges are connected to respective nodes other than the fourth node.

3. The information processing apparatus according to claim 1, wherein
a node in a vicinity of the fourth node includes one or more nodes in a vicinity of the fourth node and having no edge connected to the fourth node, and
a node in a vicinity of a node other than the fourth node includes one or more nodes in a vicinity of respective nodes other than the fourth node and having no edge connected to the respective nodes other than the fourth node.

4. The information processing apparatus according to claim 1, wherein
the processor is configured to:
estimate homophily between the first graph data and the second graph data based on similarity of local structures of the first graph data and the second graph data;
update the extraction model based on a loss of a weighted sum of the contrastive loss and the structural loss; and
adjust a weight in the weighted sum according to a degree of similarity of the local structure.

5. The information processing apparatus according to claim 1, wherein
the processor is configured to:
estimate a distribution of degrees of nodes of the first graph data and the second graph data; and
in a calculation of the structural loss, exclude a node having a degree of a predetermined value or more from the calculation of the structural loss.

6. The information processing apparatus according to claim 1, wherein the input graph data includes at least any of data of a graphed chemical molecule structure, data of a graphed citation relationship of a paper, data of a graphed purchase relationship, data of a graphed co-selling relationship of a product, data of a graphed relationship of a user in a social network, data of a graphed design drawing of an electric circuit, data of a graphed source code of a program, and a plurality of pieces of graphed sensor data.

7. The information processing apparatus according to claim 1, wherein the extraction model extracts the feature by a graph neural network having a message passing mechanism.

8. The information processing apparatus according to claim 1, wherein similarity of a feature of a node in a vicinity of a fourth node in the first graph data or the second graph data with respect to a feature of a third node in the first graph data, the fourth node being a same as the third node, is similarity of an average value of features of nodes in a vicinity of the fourth node with respect to a feature of the third node.

9. The information processing apparatus according to claim 1, wherein similarity of a feature of a node in a vicinity of a fourth node in the first graph data or the second graph data with respect to a feature of a third node in the first graph data, the fourth node being a same as the third node, is similarity of features of respective nodes in a vicinity of the fourth node with respect to a feature of the third node.

10. The information processing apparatus according to claim 1, wherein the processor is configured to calculate, instead of a structural loss according to similarity of a feature of a node in a vicinity of a fourth node in the first graph data or the second graph data with respect to a feature of the third node in the first graph data, the fourth node being a same as the third node, and similarity of a feature of a node in a vicinity of a node, other than the fourth node, in graph data to which the fourth node belongs with respect to a feature of the third node, a structural loss according to similarity of a feature of a node in a vicinity of a fourth node in the input graph data with respect to a feature of the third node in the input graph data, the fourth node being a same as the third node.

11. The information processing apparatus according to claim 10, wherein similarity of a feature of a node in a vicinity of a fourth node in the input graph data with respect to a feature of a third node in the input graph data, the fourth node being a same as the third node, is similarity of an average value of features of nodes in a vicinity of the fourth node with respect to a feature of the third node.

12. The information processing apparatus according to claim 10, wherein similarity of a feature of a node in a vicinity of a fourth node in the input graph data with respect to a feature of a third node in the input graph data, the fourth node being a same as the third node, is similarity of features of respective nodes in a vicinity of the fourth node with respect to a feature of the third node.

13. An information processing method comprising:
receiving graph data;
modifying the input graph data to generate two pieces of new graph data;
extracting, by an extraction model, features of respective nodes constituting any two pieces of first graph data and second graph data among the input graph data and the two pieces of generated graph data;
calculating a contrastive loss according to similarity of a feature of a second node in the second graph data with respect to a feature of a first node in the first graph data, the second node being a same as the first node, similarity of a feature of a node, other than the second node, in the second graph data with respect to a feature of the first node, and similarity of a feature of a node, other than the first node, in the first graph data with respect to a feature of the first node;
calculating a structural loss according to similarity of a feature of a node in a vicinity of a fourth node in the first graph data or the second graph data with respect to a feature of a third node in the first graph data, the fourth node being a same as the third node, and similarity of a feature of a node in a vicinity of a node, other than the fourth node, in graph data to which the fourth node belongs with respect to a feature of the third node; and
updating the extraction model using the contrastive loss and the structural loss.

14. A non-transitory computer-readable storage medium storing an information processing program for causing a computer to implement:
receiving graph data;
modifying the input graph data to generate two pieces of new graph data;
extracting, by an extraction model, features of respective nodes constituting any two pieces of first graph data and second graph data among the input graph data and the two pieces of generated graph data;
calculating a contrastive loss according to similarity of a feature of a second node in the second graph data with respect to a feature of a first node in the first graph data, the second node being a same as the first node, similarity of a feature of a node, other than the second node, in the second graph data with respect to a feature of the first node, and similarity of a feature of a node, other than the first node, in the first graph data with respect to a feature of the first node;
calculating a structural loss according to similarity of a feature of a node in a vicinity of a fourth node in the first graph data or the second graph data with respect to a feature of a third node in the first graph data, the fourth node being a same as the third node, and similarity of a feature of a node in a vicinity of a node, other than the fourth node, in graph data to which the fourth node belongs with respect to a feature of the third node; and
updating the extraction model using the contrastive loss and the structural loss.
